(19) United States
(12) Patent Application Publication
(10) Pub. No.: US 2005/0055297 A1
(43) Pub. Date: Mar. 10, 2005

(54) Method for funding annuities and then using the annuities to fund life insurance

(76) Inventors: Jay D. Gordon, San Diego, CA (US); Matthew E. Gordon, San Diego, CA (US)

Correspondence Address: Jay D. Gordon, 10405 San Diego Mission Rd #105, San Diego, CA, 92108, US

(21) Appl. No.: 10/657,534

(22) Filed: Sep. 5, 2003

(51) Int. Cl. G06F 17/60

(52) U.S. Cl. 705/35

(57) ABSTRACT

The present invention relates to the funding of annuities and using the annuities in a specific manner to fund life insurance. Using this method a business is able to obtain a higher than normal market return using an annuity and then applying the higher than market returns to fund life insurance. This invention also provides an effective added value to normally passive account receivables, a buy/sell vehicle, tax efficiency, asset protection as well as a vehicle to attract buyers to an otherwise unmarketable business.

### BACKGROUND OF THE INVENTION

1) Field of the Invention

The present invention relates to the funding of annuities and using the annuities in a specific manner to fund life insurance. Using this method a business is able to obtain a higher than normal market return using an annuity and then applying the higher than market returns to fund life insurance. This invention also provides an effective added value to normally passive account receivables, a buy/sell vehicle, tax efficiency, asset protection as well as a vehicle to attract buyers to an otherwise unmarketable business.

Portions of the disclosure of this patent document contains material that is subject to copyright protection. The copyright owner has no objection to the facsimile reproduction by anyone of the patent document or the patent disclosure as it appears in the Patent and Trademark office file or records, but otherwise reserves all copyrights whatsoever.

2) Prior Art

The owners of professional corporations and closely held corporations face many challenges in the economy. Maximizing return on their corporate assets, minimizing taxes, setting up buy/sell agreements with associates, attracting a buyer for the business as an exit strategy, preparing a fund for retirement, protecting assets from lawsuits, often distract the business owner from the primary activities of the company. Presently, business owners have passive account receivables that if not factored are carried on the corporate books as an asset but produce no income. There are several programs that presently attempt to use receivables in a strategy to create additional wealth for the business owner. The problem with the present methods is that they all attempt to transfer funds borrowed by the corporation to the owner personally, creating potential audit and tax issues. These programs are complex, expensive, hard to maintain and often are rejected by financial advisors and attorneys. The present invention, as one of its features avoids the transfer of borrowed funds out of the corporation to the individual and as a result is much less costly to establish and operate, is more readily accepted by financial advisors and attorneys and provides a substantial return on passive receivables.

In many professions, such as medicine, dentistry and law, the owners operate as corporations. As the owners age they may have an interest in selling the business and retiring but the population of younger professionals who can purchase the business is shrinking. The professional often emerges from training with high debt and no funds in which to buy the business. As a result, particularly in expensive to live areas, many professionals are simply closing their business reaping no value for the business. The present invention provides a method to attract a buyer of the business, without having funds with which to purchase the business, but at the same time, allows the seller to receive value for the business at retirement or sale. The logic applied to professional corporations also applies to any closely held business.

A further problem in business is the increasing probability of litigation coupled with the exploding costs of malpractice insurance. Business owners find themselves at peril for both their business assets and their personal assets since litigants often successfully pierce the corporate veil and pursue personal assets. In many areas malpractice coverage is either unavailable or so expensive as to be effectively unavailable forcing practitioners to close their businesses. Conventional means of asset protection are costly, may not hold up to legal challenge, often encumber assets so as to prevent transferring or otherwise disposing thereof. The present method solves this problem, simply, expeditiously and profitably giving the business owner greater flexibility in running his or her business.

Other issues facing a business owner are how to fund retirement. Most present plans require an administrator or manager, have costs and strict limits on contributions. The present invention creates retirement funds and insurance for the owner eliminating the costs and contribution limits set by existing retirement funds.

Further benefits of the present invention relate to insurance coverage for the owner, if the owner dies, how do his heirs continue the business. Present insurance programs are not up to the task. Term life insurance can expire before the owner dies resulting in no funds to carry on the business. Universal or whole life insurance can be so costly as to be unaffordable again leaving the owners heirs without coverage. The present invention converts an expense of the business to a retirement fund and insurance coverage that is permanent.

### SUMMARY OF THE INVENTION

The present invention utilizes traditional annuities, bank loans to the business and an optional election of insurance to provide asset protection, profit from the businesses passive accounts receivable, a vehicle for buy/sell to an associate, a purchase vehicle for a new buyer.

In one embodiment of the invention; the preferred funding vehicle for the benefits of the invention is a bank loan made to the corporation for general corporate purposes. For such a loan, the loan interest typically would be expensed on the corporate tax return. The funds are then used to purchase a standard annuity that is owned by the corporation. In one form of the invention, the annuity would be of the index annuity variety allowing the business to experience current stock market index returns with no risk to principal and the gains being locked in each year. Because the gains are not credited to the account until the end of the accumulation period there is no current taxation of the gains.

In another version of the invention, the funds are used to purchase a standard fixed annuity. Such annuities often have minimum guaranteed interest rates, a surrender charge, and often a maximum withdrawal permitted without surrender charges.

In yet another version of the invention, the corporation also buys a life insurance policy on the owner, an employee or a related party in which the corporation would have an insurable interest. The insurance policy can be term life or permanent, sometimes known as universal life. Typically universal life would be funded by a large single premium, a series of premiums for a number of years, or a regular premium paid until death. In any of these traditional funding methods it takes years for the client to get to the break even point as there are substantial loading factors that severely impact the cash value of the policy. The present invention utilizes funding the insurance in a novel way such that the insurance becomes profitable to the corporation in as early as the second or third year.

In one version the income from the annuity, which income is usually greater than, for example, certificates of deposits is used as the premium for the universal life. The income is used to fund the premiums until the expiration of the surrender period at which time the corpus is added to the universal life. In this manner the loading is minimized and the cash accumulates at a much faster rate than conventional methods. To further maximize cash values, the full yearly penalty free withdrawals are used to fund the universal life until a point is reached where it is more profitable to absorb a small surrender charge and then fully fund the universal life than to wait until the expiration of the penalty period. Cash values are further enhanced by providing for minimum death benefit for the specific premium amounts initially determined by the bank loan amount.

The present invention successfully accomplishes a variety of objectives. The corporation obtains a higher than market rate return on its previously passive accounts receivable. The corporation has a mechanism for buy/sell to an associate such mechanism being the cash value of the policy. The corporation also provides permanent insurance for the heirs of the owner, which is done at a profit to the corporation rather than an expense. A mechanism now exists for a buyer to purchase the corporation, even if the buyer lacks the funds for such purchase. This is accomplished by the buyer assuming the bank loan, continuing the loan payments and the seller realizing the gains of the annuities and or insurance policies. The objective of obtaining asset protection is accomplished by the corporation taking life annuity payments from the annuity, or the life insurance cash value. This has the effect of converting a substantial single sum, say $500,000 into a life income of say $40,000 per year. Such a conversion has the effect of reducing the attractiveness of the assets in the corporation for potential litigants. Further, the owner of the corporation can pledge his personal assets to the bank for the corporate loan. This provides additional asset protection for the owners personal assets at no set-up expense or recurring charges while at the same time permitting the owner to manage these assets without restriction so long as the bank retains a security interest in the assets.

Further objectives of this invention will be brought out in the following part of the specification, wherein a detailed description is for the purpose of fully disclosing the invention without placing limitations thereon.

### DETAILED DESCRIPTION OF THE INVENTION

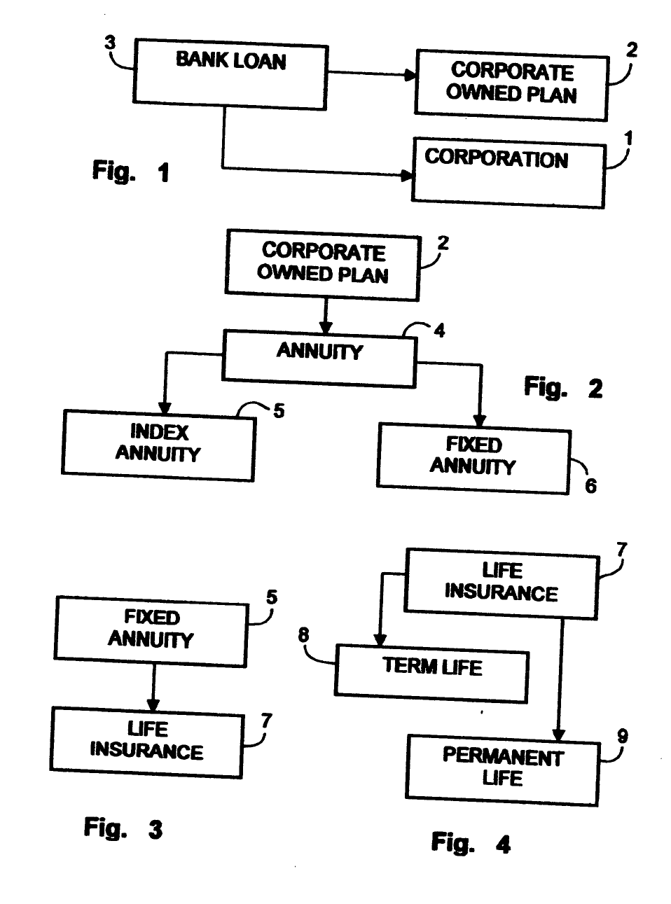

As shown in FIG. 1 one manifestation of the present invention relates to a corporation (1) or limited liability company owning a plan (2). This incorporates asset protection, a high yielding investment, a buy sell format, a recruitment vehicle for new professionals, life insurance for corporate succession and tax efficiency. The plan can be funded by a bank loan.

In FIG. 2 it is shown that the corporation (1) purchases an annuity (4). This is not a typical transaction in that a corporation as a non-natural person gets none of the tax benefits of a standard annuity, the inside buildup is taxable each year. The great advantage of a corporation purchasing an annuity is that annuities have higher long term yields than other safe fixed investments, approximately 1% than say CD's. Yet another advantage is that even though the traditional annuity is not treated as such for tax purposes, it still can be annuitized. This rather important feature allows the conversion of a large sum, say $500,000 into a life income of say $40,000 per year. In a society that is increasingly litigious this feature can be a very important asset protection strategy.

Traditional asset protection is costly, complex and fraught with risk that the strategy will be disallowed by certain courts. By way of example, certain instruments known as family limited partnerships are commonly used as vehicles for estate tax reduction as well as asset protection. Increasingly, courts are whittling away at FLP's and even if they are not impacted by the legal system, they are expensive and complex. Furthermore, FLP's can inhibit the efficient use of corporate assets. An asset that is subject to litigation that is in an FLP is often hard to sell or otherwise dispose of since a buyer would be reluctant to purchase an asset that is in an FLP and subject to litigation. When a corporation owns an annuity, it can convert the lump sum into a series of yearly payments that are less than 10% of the corpus. This makes it much less attractive to sue the corporation since a small income flow is not the typical reward that litigants are after.

FIG. two shows two versions of using the annuity. In the version identified as index annuity a standard S & P index or other index such as Nasdaq annuity is used. The advantage of this annuity is that while it can be annuitized for asset protection, it locks in index gains each year with no possibility of losses in ensuing years. Furthermore, the historical average index movement year to year is 15%, up or down. By doing a historical analysis of index movement for over 75 years 15% is the average movement. This results in a very probable average net 10% per year gain with no risks. This is an obviously very desirable yield for long term safe income. In addition, index annuities often don't vest the appreciation until the end of a long time period so that effectively provides for tax deferral as well as high yield.

The other option is using a regular fixed annuity, the virtue of which is to provide a regular fixed income that is available to pay into the life insurance component. Using the income from the annuities to pay the premiums of the life insurance is illustrated in FIGS. 3 and 4, using term life (8) or permanent life (9).

In FIG. 6 the annuity is used to pay the premium for the life insurance (7). Most universal life insurance is structured such that the loading burden is heavily front weighted. This usually means the universal life investor waits many years, if ever, for the universal to become a profitable investment. The invention as shown in FIGS. 6 and 7 moderates the addition of premiums into the policy such that in the first year the premium is minimum, in the ensuing years the premium is composed of the maximum penalty free partial withdrawals (10), followed by the corpus (12). This has the effect of creating a profit in as early as the 3^{rd} year in contrast to up to 10 years and more for traditional universal life premium funding. In FIG. 7 the premium funding is identical to that of FIG. 6 except that the yield of the universal life is further enhanced by calculating on a year to year basis, to see at what year the annuity surrender charge is offset or superceded by the increase in cash buildup in the universal life policy (11), again followed by the corpus (12). Since each annuity contract and each universal life policy is unique, such calculations must be made for each combination but the uniqueness of the present invention maximizes the universal life values in the vast majority of annuity/universal life combinations at around the 8^{th} or 9^{th} year, though certain rare combinations might produce an earlier or later year maximum value.

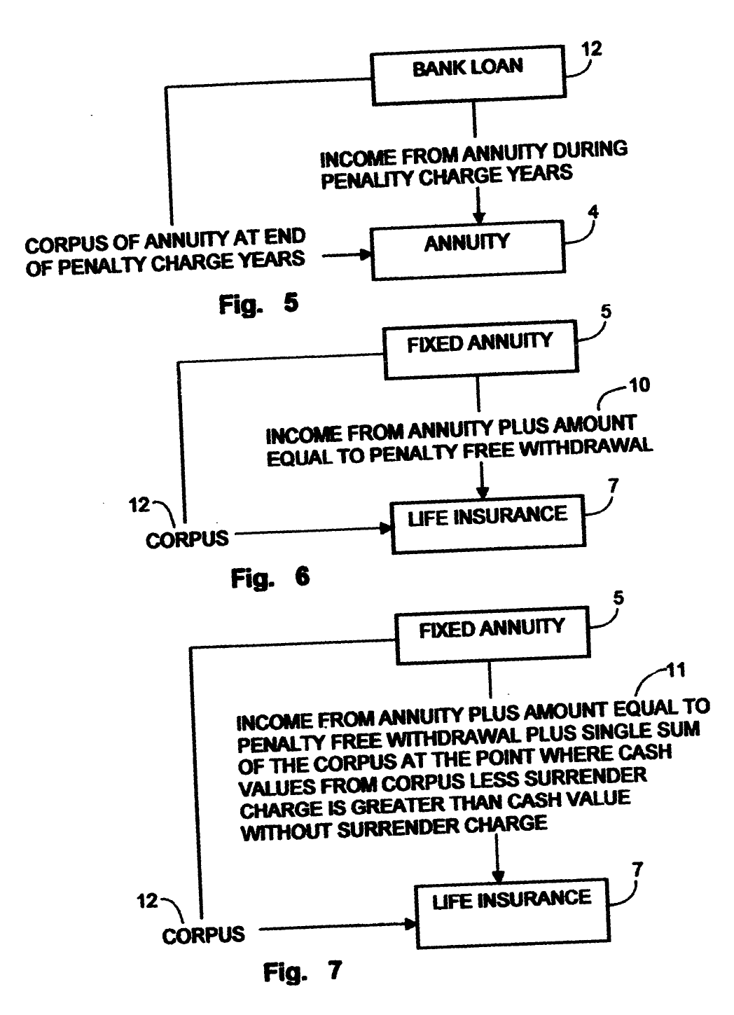

As shown in FIG. 5 the annuity can be funded via a bank loan (12). The advantage of the bank loan is that borrowed funds can have an interest rate that is lower than the yield produced by the annuity and universal life thus producing a profit from funds not otherwise producing a profit from funds not otherwise available in the corporation. This represents a significant averaging of the benefits of the invention.

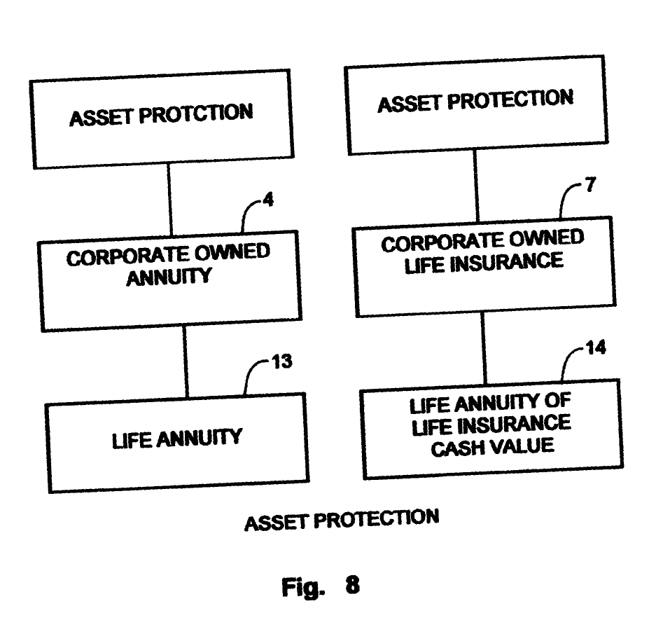

FIG. 8 shows the use of both the annuity and the life insurance in asset protections. Both the annuity and life insurance cash values can be annuitized (13,14) over extended periods to reduce the likelihood that litigants will find assets worth pursuing.

While all of the fundamental characteristics and features of the present invention have been described herein, with reference to particular embodiments thereof, a latitude of modification, various changes and substitutions are intended in the forgoing disclosure and it will be apparent that in some instances, some features of the invention will be employed without a corresponding use of other features without departing from the scope of the invention as set forth. It should be understood that such substitutions, modifications and variations may be made by those skilled in the art without departing from the spirit or scope of the invention. Consequently, all such modifications and variations are included within the scope of the invention as defined by the following claims and their full scope of equivalents.

1) a method for funding a business financial plan comprising the steps of:
a) the business borrowing funds, said loan based upon collateral;
b) said business purchasing an annuity

2) The method for funding a business financial plan of claim 1, wherein the step of purchasing an annuity, the annuity is an index annuity.

3) The method for funding a business financial plan of claim 1, wherein the step of purchasing an annuity, the annuity is a fixed annuity.

4) The method for funding a business financial plan of claim 1, further comprising the steps of the business purchasing a life insurance policy.

5) The method for funding a business financial plan of claim 1, further comprising the steps of the business purchasing a term life insurance policy.

6) The method for funding a business financial plan of claim 1, further comprising the steps of the business purchasing a permanent life insurance policy.

7) The method for funding a business financial plan of claim 1, further comprising the steps of the business purchasing a universal life insurance policy.

8) The method for funding a business financial plan of claim 7, wherein the method of purchasing the universal life policy further includes using the income from the annuity to pay the premium of the universal life policy

9) The method for funding a business financial plan of claim 8, wherein the method of purchasing the universal life policy further includes using the annuity corpus at the end of the surrender charge period to pay a premium of the universal life.

10) The method for funding a business financial plan of claim 7, wherein the method of purchasing the universal life policy wherein the maximum partial penalty free withdrawals from the annuity are used to pay the universal life premiums.

11) The method of funding a business financial plan of claim, wherein the method of purchasing the universal life policy of claim 6 wherein the cash value of the permanent life is annuitized to create an income flow for the business.

12) The method of funding a business financial plan of claim 6, wherein the method of purchasing the universal life wherein income from the annuity plus an amount equal to the penalty free withdrawals plus the single sum of the corpus at the point where cash values from the corpus less the annuity surrender charge is greater than the annuity cash value without the surrender charge are used to fund the universal life.

13) The method of funding a universal life policy with an annuity in wherein income from the annuity plus an amount equal to the penalty free withdrawals plus the single sum of the corpus at the point where cash values from the corpus less the annuity surrender charge is greater than the annuity cash value without the surrender charge are used to fund the universal life.
